(19) United States
(12) Patent Application Publication
(10) Pub. No.: US 2015/0347213 A1
(43) Pub. Date: Dec. 3, 2015

(54) APPARATUS AND METHOD FOR SYSTEM MONITORING

(71) Applicant: SAMSUNG SDS CO., LTD., Seoul (KR)

(72) Inventors: Kyu Sam OH, Seoul (KR); Hyung Chan KIM, Seoul (KR); Bum Jun SEO, Seoul (KR); Soon Hwan KWON, Seoul (KR); Sang Won CHO, Seoul (KR)

(73) Assignee: SAMSUNG SDS CO., LTD., Seoul (KR)

(21) Appl. No.: 14/616,131

(22) Filed: Feb. 6, 2015

(30) Foreign Application Priority Data
May 30, 2014 (KR) 10-2014-0066494
Oct. 2, 2014 (KR) 10-2014-0133525

(51) Int. Cl. G06F 11/07; G06F 11/34

(52) U.S. Cl. CPC G06F 11/079; G06F 11/0751; G06F 11/3409

(57) ABSTRACT

There is provided an apparatus for monitoring the target system. The apparatus includes: a data collection unit configured to collect a first data set acquired from a target system at a first time point and determined to represent a status of the target system and a second data set acquired from the target system at a second time point subsequent to the first time point; and a calculation unit configured to calculate at least one index associated with the status of the system based on the first data set and the second data set, wherein at least one of the data collection unit and the calculation unit are implemented via at least one central processing unit or at least one hardware processor.

### CROSS-REFERENCE TO RELATED APPLICATION

This application claims priority from Korean Patent Applications Nos. 10-2014-0066494, filed on May 30, 2014, and 10-2014-0133525, filed on Oct. 2, 2014 in the Korean Intellectual Property Office, the disclosure of each of which is incorporated herein by reference in its entirety.

### BACKGROUND

1. Field

Exemplary embodiments of the present disclosure relate to an apparatus and method for system monitoring, and more particularly, to diagnosing and indexing a status of a computer system.

2. Discussion of Related Art

With the development of information communication technologies, demands for services to monitor and control a status of a computer system using sensors have been increased. The status of the computer system may be monitored based on sensor values detected by the sensors. Typically, such monitoring of the system involves determining whether the system is normal or whether a defect has occurred in the system.

However, existing system monitoring technologies are not useful for detecting a potential defect in the system. This is because generally the conventional technologies merely notify a user of a situation in which a defect has already occurred, and set, in a defensive manner, a threshold value for determining that such a situation has occurred if there is a very low probability that the system is not normal. In addition, with respect to a system having high complexity, the above-described dichotomous determination is difficult to show satisfactory performance. Therefore, there have been demands for improved technologies for monitoring the system to diagnose the status of the system.

### SUMMARY

Exemplary embodiments address at least the above problems and/or disadvantages and other disadvantages not described above. Also, the exemplary embodiments are not required to overcome the disadvantages described above, and may not overcome any of the problems described above.

One or more exemplary embodiments provide a system monitoring apparatus and a system monitoring method

According to an exemplary embodiment, there is provided an apparatus for monitoring a target system. The apparatus may comprise a data collection unit configured to collect a first data set acquired from the target system at a first time point and determined to represent a status of the target system and a second data set acquired from the target system at a second time point subsequent to the first time point; and a calculation unit configured to calculate at least one index associated with the status of the system based on the first data set and the second data set, wherein at least one of the data collection unit and the calculation unit are implemented via at least one central processing unit or at least one hardware processor.

The first data set may indicate whether the status of the target system at the first time point is a normal status or a faulty status.

The at least one index may include a basic status index value associated with the status of the target system at the second time point.

The at least one index may further include an operating status index value associated with the status of the target system over a time interval from the first time point to the second time point.

The calculation unit may calculate the operating status index value from a plurality of time point-specific basic status index values, and each of the plurality of time point-specific basic status index values may be associated with the status of the target system at one time point within the time interval.

The target system may include a plurality of lower level systems, and the at least one index may include a lower level-status index value associated with a status of one lower level system among the plurality of lower level systems at the second time point.

The calculation unit may calculate the lower level-status index value from a plurality of lower level system-specific basic status index values, and each of the plurality of lower level system-specific basic status index values may be associated with the status of one lower level system among the plurality of lower level systems at the second time point.

The lower level-status index value may be a minimum value among the plurality of lower level system-specific basic status index values.

The system monitoring apparatus may further include: an interface unit configured to indicate the at least one index through a user interface.

The system may include a plurality of lower level systems, the calculation unit may further calculate a plurality of lower level system-specific indexes, the interface unit may further indicate at least a part of the plurality of lower level system-specific indexes in the user interface in response to reception of a user input, and each of the plurality of lower level system-specific indexes may be associated with a status of a corresponding lower level system among the plurality of lower level systems.

The interface unit may further represent at least one of the plurality of lower level systems in a highlighted format.

The calculation unit may further calculate a degree of similarity between the first data set and the second data set, and the apparatus may further include: a determination unit that determines, based on a threshold value associated with the first data set and the degree of similarity, whether the second data set represents an abnormality sign status, the normal status, or the faulty status of the target system.

The calculation unit may further calculate the at least one index from the degree of similarity.

The first data set may include a plurality of first sensor values measured through a plurality of sensors installed in association with the system, and the second data set may include a plurality of second sensor values measured through the plurality of sensors.

The calculation unit may further calculate a degree of contribution of each of the plurality of sensors with respect to the degree of similarity when the second data set is determined to represent the faulty status or the abnormality sign status.

The determination unit may further select, based on the calculated degree of contribution, one of the plurality of sensors as a sensor to be inspected.

The degree of similarity may represent a distance between the first data set and the second data set in accordance with a preset distance metric.

The second data set may be determined to represent the normal status when the distance is smaller than the threshold value and the first data set is determined to represent the normal status, the second data set may be determined to represent the faulty status when the distance is smaller than the threshold value and the first data set is determined to represent the faulty status, and the second data set may be determined to represent the abnormality sign status when the distance is larger than the threshold value.

The calculation unit may further calculate, from the distance, a basic status index value associated with the status of the target system at the second time point, the basic status index value may be calculated based on a decreasing function with respect to the distance when the first data set is determined to represent the normal status, and the basic status index value may be calculated based on an increasing function with respect to the distance when the first data set is determined to represent the faulty status.

According to another exemplary embodiment, there is provided a system monitoring method which is implemented by a computing device, including: collecting a first data set acquired from a target system at a first time point and determined to represent a status of the system and a second data set acquired from the system at a second time point subsequent to the first time point; and calculating at least one index associated with the status of the target system based on the first data set and the second data set.

The first data set may be determined to represent the status of the target system at the first time point as a normal status or a faulty status.

The at least one index may include a basic status index value associated with the status of the target system at the second time point.

The at least one index may include an operating status index value associated with the status of the target system over a time interval from the first time point to the second time.

The calculating may include calculating the operating status index value from a plurality of time point-specific basic status index values, and each of the plurality of time point-specific basic status index values may be associated with the status of the target system at one time point within the time interval.

The target system may include a plurality of lower level systems, and the at least one index may further include a lower level-status index value associated with a status of one lower level system among the plurality of lower level systems at the second time point.

The calculating may include calculating the lower level-status index value from a plurality of lower level system-specific basic status index values, and each of the plurality of lower level system-specific basic status index values may be associated with the status of one lower level system among the plurality of lower level systems at the second time point.

The lower level-status index value may be a minimum value among the plurality of lower level system-specific basic status index values.

The system monitoring method may further include: representing the index through a user interface.

The method may further include: calculating a plurality of lower level system-specific indexes corresponding to a plurality of lower level systems of the target system; and indicating at least a part of the plurality of lower level system-specific indexes through the user interface in response to reception of a user input, and each of the plurality of lower level system-specific indexes may be associated with a status of a corresponding lower level system among the plurality of lower level systems.

The system monitoring method may further include: representing at least one of the plurality of lower level systems in a highlighted format.

The system monitoring method may further include: calculating a degree of similarity between the first data set and the second data set; and determining, based on a threshold value associated with the first data set and the degree of similarity, whether the second data set represents an abnormality sign status, the normal status, or the faulty status of the target system.

The system monitoring method may further include: calculating the index from the degree of similarity.

The first data set may include a plurality of first sensor values measured through a plurality of sensors installed in association with the target system, and the second data set may include a plurality of second sensor values measured through the plurality of sensors.

The system monitoring method may further include: calculating a degree of contribution of each of the plurality of sensors with respect to the degree of similarity when the second data set is determined to represent the faulty status or the abnormality sign status.

The system monitoring method may further include: selecting, based on the calculated degree of contribution, one of the plurality of sensors as a sensor to be inspected.

The degree of similarity may represent a distance between the first data set and the second data set in accordance with a preset distance metric.

The second data set may be determined to represent the normal status when the distance is smaller than the threshold value and the first data set is determined to represent the normal status, the second data set may be determined to represent the faulty status when the distance is smaller than the threshold value and the first data set is determined to represent the faulty status, and the second data set may be determined to represent the abnormality sign status when the distance is larger than the threshold value.

The system monitoring method may further include: calculating, from the distance, a basic status index value associated with the status of the system at a second time point, the basic status index value may be calculated based on a decreasing function with respect to the distance when the first data set is determined to represent the normal status, and the basic status index value may be calculated based on an increasing function with respect to the distance when the first data set is determined to represent the faulty status.

According to still another exemplary embodiment, there is provided a system monitoring apparatus including: a calculation unit configured to acquire a system status index including a basic status index value associated with a time point-specific status of a target system, at least one of an operating status index value associated with a time interval-specific status of the target system, and a lower level-status index value associated with a time point-specific status of a specific lower level system of the system; and an interface unit configured to indicate the system status index through a user interface, wherein at least one of the calculation unit and the interface unit are implemented via at least one central processing unit or at least one hardware processor.

The basic status index value may represent the status of the target system at a second time point, the operating status index value may represent the status of the target system over a time interval from a first time point preceding the second time point to the second time point, and the lower level-status index value may represent the status of the specific lower level system at the second time point.

The calculation unit may acquire the operating status index value using a plurality of time point-specific basic status index values, and each of the plurality of time point-specific basic status index values may be associated with the status of the target system at one time point within the time interval.

The calculation unit may acquire the lower level-status index value using a plurality of lower level system-specific basic status index values, the system may include a plurality of lower level systems, the plurality of lower level systems may include the specific lower level system, and each of the plurality of lower level system-specific basic status index values may be associated with a status of one lower level system among the plurality of lower level systems at the second time point.

The lower level-status index value may be a minimum value among the plurality of lower level system-specific basic status index values.

The system may include a plurality of lower level systems, the plurality of lower level systems may include the specific lower level system, the calculation unit may further acquire a plurality of lower level system-specific system status indexes, each of the plurality of lower level system-specific system status indexes may be associated with a status of a corresponding lower level system among the plurality of lower level systems, and the interface unit may further represent at least a part of the plurality of lower level system-specific system status indexes through the user interface.

The interface unit may further represent at least one of the plurality of lower level systems in a highlighted format through the user interface.

According to still another exemplary embodiment, there is provided a system monitoring method including: acquiring a system status index including a basic status index value associated with a time point-specific status of a target system, at least one of an operating status index value associated with a time interval-specific status of the target system and a lower level-status index value associated with a time point-specific status of a specific lower level system of the target system; and representing the system status index through a user interface.

The basic status index value may represent the status of the target system at a second time point, the operating status index value may represent the status of the system over a time interval from a first time point preceding the second time point to the second time point, and the lower level-status index value may represent the status of the specific lower level system at the second time point.

The acquiring may include acquiring the operating status index value using a plurality of time point-specific basic status index values, and each of the plurality of time point-specific basic status index values may be associated with the status of the system at one time point within the time interval.

The acquiring may include acquiring the lower level-status index value using a plurality of lower level system-specific basic status index values, the system may include a plurality of lower level systems, the plurality of lower level systems may include the specific lower level system, and each of the plurality of lower level system-specific basic status index values may be associated with a status of one lower level system among the plurality of lower level systems at the second time point.

The lower level-status index value may be a minimum value among the plurality of lower level system-specific basic status index values.

The method may further include: acquiring a plurality of lower level system-specific system status indexes corresponding to a plurality of lower level systems of the target system, wherein each of the plurality of lower level system-specific system status indexes may be associated with a status of a corresponding lower level system among the plurality of lower level systems, and representing at least a part of the plurality of lower level system-specific system status indexes through the user interface.

The system monitoring method may further include: representing at least one of the plurality of lower level systems in a highlighted format through the user interface.

According to still another exemplary embodiment, there is provided a non-transitory computer-readable storage medium storing a program executable by a processor to perform a method including: collecting a first data set acquired from a target system at a first time point and determined to represent a status of the target system and a second data set acquired from the target system at a second time point subsequent to the first time point; and calculating at least one index associated with the status of the target system based on the first data set and the second data set.

According to still another exemplary embodiment, there is provided a non-transitory computer-readable storage medium storing a program executable by a processor to perform a method including: acquiring a system status index including a basic status index value associated with a time point-specific status of a target system, at least one of an operating status index value associated with a time interval-specific status of the target system, and a lower level-status index value associated with a time point-specific status of a specific lower level system of the target system; and representing the system status index through a user interface.

According to still another exemplary embodiment, there is provided an apparatus for monitoring a target system. The apparatus may include a database configured to store a first data set corresponding to a first sensing value acquired from the target system at a first time point and indicating an operation status of the target system at the first time point; a data collection unit configured to acquire a second data set corresponding to a second sensing value acquired from the target system at a second time point subsequent to the first time point; and a determination unit configured to determine an operation status of the target system at the second time point based on a degree of similarity between the first data set and the second data set, wherein at least one of the data collection unit and the determination unit are implemented via at least one central processing unit or at least one hardware processor.

The determination unit may be further configured to determine the operation status at the second time point as normal or faulty based on the degree of similarity and the operation status at the first time point in response to the degree of the similarity being higher than a threshold value.

The determination unit may be further configured to determine the operation status at the second time point as abnormal in response to the degree of similarity being lower than the threshold value.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 illustrates an operating environment in which a system monitoring apparatus according to an exemplary embodiment is disposed;

FIG. 2 illustrates a system status index according to an exemplary embodiment;

FIG. 3 illustrates a user interface according to an exemplary embodiment;

FIG. 4 illustrates a calculation of a degree of similarity and system status determination according to an exemplary embodiment;

FIG. 5 illustrates a user interface according to an exemplary embodiment;

FIG. 6 illustrates a system monitoring process according to an exemplary embodiment;

FIG. 7 illustrates a system monitoring process according to an exemplary embodiment; and

FIGS. 8 to 10 illustrate different examples of system status indexes.

### DETAILED DESCRIPTION OF EXEMPLARY EMBODIMENTS

Hereinafter, detailed embodiments of the present disclosure will be described with reference to the accompanying drawings. The following detailed description is provided to help comprehensive understanding of methods, devices and/or systems described in this specification. However, these are only examples, and the present disclosure is not limited thereto.

In the description below, when it is determined that detailed descriptions of related well-known functions unnecessarily obscure the gist of the present disclosure, detailed descriptions thereof will be omitted. Some terms described below are defined by considering functions in the present disclosure and meanings may vary depending on, for example, a user or operator's intentions or customs. Therefore, the meanings of terms should be interpreted based on the scope throughout this specification. The terminology used in detailed description is provided to only describe the example embodiments and not for purposes of limitation. Unless the context clearly indicates otherwise, the singular forms include the plural forms. It will be understood that the terms “comprises” or “includes” when used herein, specify some features, numbers, steps, operations, elements, and/or combinations thereof, but do not preclude the presence or possibility of one or more other features, numbers, steps, operations, elements, and/or combinations thereof in addition to the description. Likewise, the description of an example embodiment in terms of a combination of elements does not preclude the implementation of a suitable subcombination of elements.

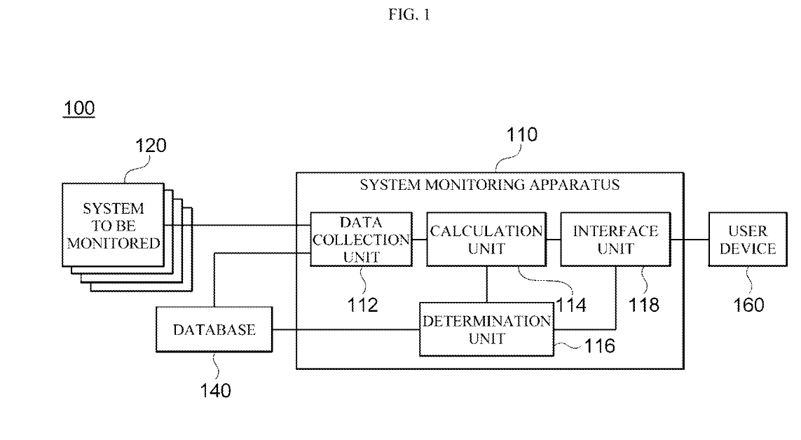

FIG. 1 illustrates an operating environment in which a system monitoring apparatus according to an embodiment is disposed.

An operating environment 100 includes a system monitoring apparatus 110, at least one system 120 to be monitored (also referred to as a target system 120), a database 140, and a user device 160.

The system 120 may be an intelligent management/control system that provides services with respect to buildings, devices provided in such buildings, or other types of facilities. The system 120 may include various sensors installed in such facilities, such as, for example, temperature sensor, humidity sensor, or opening degree sensor. In addition, the system 120 may further include an actuator for driving sensors, a controller for controlling facilities, and the like. The system 120 may provide data including sensor values measured by the sensors to the system monitoring apparatus 110.

The system monitoring apparatus 110 may collect data sets from the system 120 and the database 140, and monitor the system 120 based on the collected data sets. Each of the data sets may include sensor values measured through a plurality of sensors installed on the system 120. According to several embodiments, the system monitoring apparatus 110 may be implemented or included in a computing device. Such a computing device may include at least one processor and a computer-readable storage medium that is accessible by the processor. The computer-readable storage medium may be disposed inside or outside the processor, and connected to the processor by well-known various means. In the computer-readable storage medium, computer-executable instructions may be stored. The processor may execute the instructions stored in the computer-readable storage medium. Such instructions may enable the computing device to perform operations according to an embodiment when being executed by the processor.

The system monitoring apparatus 110 may determine a status of the system 120 from the data set newly acquired from the system 120. According to several embodiments, the system monitoring apparatus 110 may determine that the newly acquired data set represents a status of the system 120 at a specific time point, and the status may be one of the following statuses:

Normal status: the system 120 is normal

Faulty status: the system 120 is faulty

Abnormality sign status: the system 120 shows an abnormality sign

For convenience, hereinafter, a data set representing a normal status of a system such as the system 120, a data set representing a faulty status of the system, and a data set representing an abnormality sign status of the system may be respectively referred to as “normal data”, “faulty data”, and “abnormality sign data”. In addition, the above-described determination performed by the system monitoring apparatus 110 may be referred to as “system status determination”.

The system monitoring apparatus 110 may determine whether a new data set is normal data, faulty data, or abnormality sign data using the data set that is determined to represent the status of the system 120 at a preceding time point. The used data set may be a data set previously determined as normal data or faulty data. When the new data set is determined to be normal data or faulty data, the determined data set may be also used in determination of the subsequent data set.

The database 140 may maintain the data set determined to be the normal data or faulty data together with the status of the system represented by the determined data set. For example, when any data set is normal data or faulty data based on the determination result by the system monitoring apparatus 110 as described above, the corresponding data set may be stored in the database 140. In another example, when a user of the system monitoring apparatus 110 directly determines that any data set is normal data (or faulty data in some cases), the corresponding data set may be also stored in the database 140. Such a data set may be required for an initial system status determination of the system monitoring apparatus 110. In addition, when the data set has been determined as abnormality sign data through the system monitoring apparatus 110 and presented to a user who determines the abnormality sign data as normal data or faulty data, the data set and the status determined by the user may be stored in the database 140 to determine a subsequent system status of the system 120. Based on such interactions between the user and the system monitoring apparatus 110, the status of the system 120 may be efficiently determined even if the faulty status of the system is not clearly defined in advance. In such a method, even when a user has some knowledge without being specialized in the system 120, the user may diagnose and/or operate the status of the system 120.

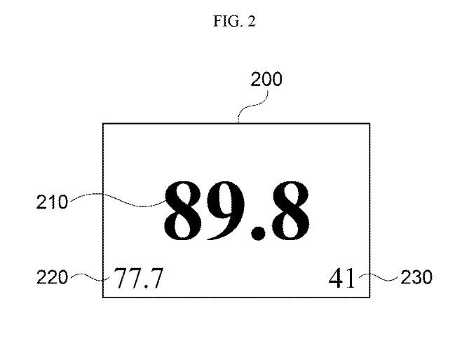

In addition, the system monitoring apparatus 110 may calculate a system status index associated with the status of the system 120 based on the data set newly acquired from the system 120 or the data set previously determined to be faulty data. The calculated index may be represented through a user interface provided in the user device 160. The user may efficiently recognize the status of the system 120 by utilizing the system status index. For example, the system monitoring apparatus 110 may provide a graphic user interface including a graphical representation 200 shown in FIG. 2 to the user device 160 such as a display device. The graphical representation 200 of FIG. 2 visually shows the system status index. The graphical representation 200 may include at least one graphical representation 210, 220, and/or 230 of index values which will be described below.

Basic Status Index Value

The system status index may include an index value that can be referred to as “basic status index value”. The basic status index value may be associated with the status of the system 120 at a specific time point. For example, the basic status index value may be set as a value within an appropriate range (for example, 0 to 100%) so as to represent a current status of the system 120. For example, the basic status index values of 10% and 90% may respectively represent that the system 120 does not properly operate and that the system 120 normally operates. Thus, a user may easily diagnose the status of the system 120, and inspect whether a failure occurs in the system 120.

Operating Status Index Value

The system status index may further include another index value that can be referred to as “operating status index value”. The operating status index value may be associated with the status of the system 120 over a time interval between specific points of time. As described above, the basic status index value may represent the status of the system 120 at a current time point, whereas the operating status index value may be set to represent the status of the system 120 over a specific time interval such as, for example, from a preceding time point to a current time point. For example, the operating status index value may be calculated from basic status index values which are respectively calculated at corresponding time points within the time interval. In view of the foregoing, if the status of the system 120 changes at a certain time point but the change occurs during a normal operation of the system 120 (for example, a case in which a boiler of a building is running in the winter and sensors in the building detect changes in temperature), the operating status index value will change gradually over a long period of time and thereby provide information indicating that the system 120 is operating normally.

Index Value Associated with Status of a Higher Level System Including Lower Level Systems

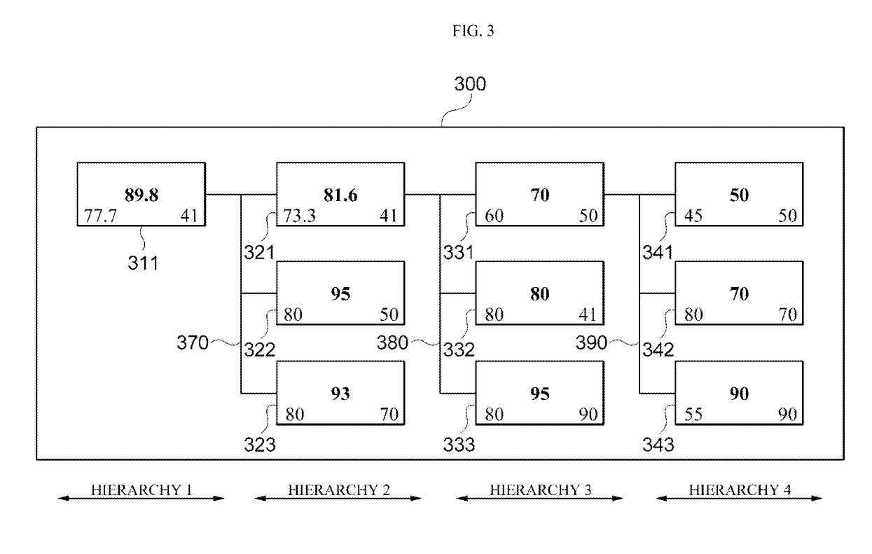

According to several embodiments, the operating environment 100 may include a plurality of target systems 120 to be monitored, and the plurality of target systems 120 may be a plurality of lower level systems included in a higher level system. For example, the higher level system may correspond to a building in which sensors are disposed, and each of the systems 120 may correspond to different devices in which the sensors are disposed, such as, for example, an air conditioner, a cooling tower, a generator, a boiler, or a heat exchanger for heating. Furthermore, the plurality of target systems 120 may be classified into a plurality of higher level systems, and the plurality of higher level systems may constitute a single highest level system. In this manner, the highest level system may be represented as a plurality of hierarchies. For example, as shown in FIG. 3, the highest level system may be represented as four hierarchies 1-4. Hierarchy 1 is the highest level hierarchy and hierarchy 4 is the lowest level of the hierarchy among the four hierarchies 1-4. In this example, the entire system may be a hierarchy 1-system, and include three lower level systems on the “hierarchy 2” level. In addition, one of the three hierarchy 2-systems may include three lower level systems on the “hierarchy 3” level. Similarly, one of the three hierarchy 3-systems may include three hierarchy 4-systems.

The system monitoring apparatus 110 may perform the above-described operations on each of the plurality of target systems 120. In addition, the system monitoring apparatus 110 may provide a bottom-up approach method for monitoring a higher level system including the plurality of target systems 120.

For example, the system monitoring apparatus 110 may calculate the following values as the system status index of the higher level system. First, the basic status index value of the higher level system may be calculated from the basic status index values of each of the plurality of target systems 120. In addition, the system monitoring apparatus 110 may calculate the operating status index value of the higher level system from the basic status index values of the higher level system which are calculated at respective monitoring time points within a specific time interval. Furthermore, the system monitoring apparatus 110 may calculate an index value associated with a status of one of the lower level systems, that is, the plurality of target systems 120. The index value may be referred to as a “lower level-status index value”. For example, the lower level-status index value may be calculated from lower level system-specific basic status index values which are respectively calculated with respect to the lower level systems at a specific time point. When such a lower level-status index value is provided to a user together with the basic status index value and operating status index value of the higher level system, the user may conveniently monitor the system up to a specific lower level system as well as the higher level system at a time. For example, the system monitoring apparatus 110 may calculate a minimum value among the basic status index values of the lower level systems as the lower level-status index value. From this, the lower level-status index value may be particularly referred to as a “minimum status index value” of the higher system. When the higher level system includes a large number of lower level systems, it may be difficult for a user to detect an occurrence of a fault in any lower level system if only the basic status index value of the higher level system is provided to the user. For example, when 99 out of 100 target systems 120 have a basic status index value of 1, but the remaining one has a basic status index value of 0, an average value (i.e., 0.99) or average percentage (i.e., 99%) of the 100 basic status index values may be presented to the user as the basic status index value of the higher level system. Thus, the minimum status index value (i.e., 0%) of the higher level system may enable a user to recognize the necessity of detailed fault inspection.

Next, the system monitoring apparatus 110 may provide the user interface including the graphical representation 200 of FIG. 2 to the user device 160. As shown in FIG. 2, the graphical representation 200 may include graphical representations 210, 220, and 230 each indicating a basic status index value, an operating status index value, and a lower level-status index value (for example, minimum status index value) of the higher level system. According to several embodiments, the system monitoring apparatus 110 may initially represent the system status index of the higher level system through the user interface, and finally display the system status indexes of the lower level systems on the user device 160 through the user interface when a specific user is input such as, for example, mouse clicking for selecting the graphical representation 200.

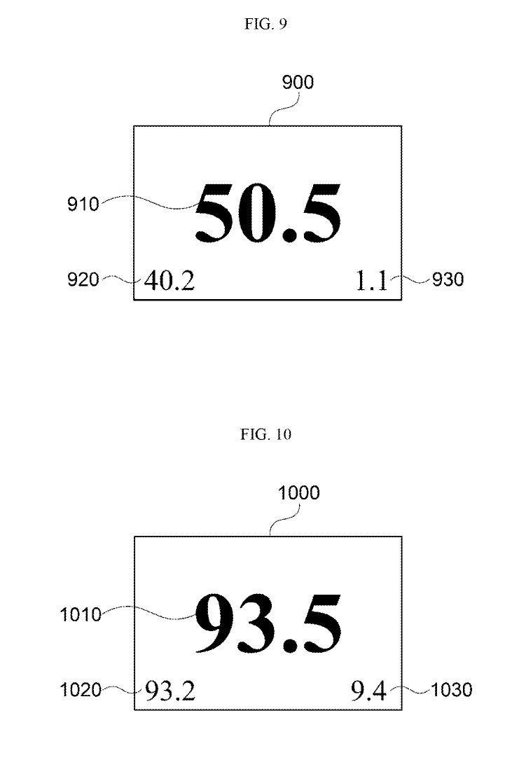

Thus, in accordance with the above-described system status index represented on the user interface, a user may efficiently discern a time point-specific status of the system 120, a time interval-specific status of the system 120, and a time point-specific status of a lower level system, if any, of the system 120, even when the user has a lack of professional knowledge. As examples, each of FIGS. 8 to 10 shows a graphical representation indicating a different system status index according to an embodiment.

As an example, graphical representation 800 of FIG. 8 includes graphical representations 810, 820, and 830. The graphical representations 810, 820, and 830 respectively indicate a basic status index value, an operating status index value, and a minimum status index value of the system 120. FIG. 8 show that that there is no significant difference between each of the operating status index value and the minimum status index value with the basic status index value. In this case, the user may rapidly recognize that a change in the operation of the system 120 or a fault of a specific lower level system of the system 120 is in the normal range of operations and may not require further attention or inspection.

As another example, the graphical representation 900 of FIG. 9 includes graphical representations 910, 920, and 930. A basic status index value indicated by the graphical representation 910 is not significantly high, and an operating status index value indicated by the graphical representation 920 also has a low value. Thus, a user may determine that a possibility of generation of a factor such as a change in the operation of the system 120 or deterioration of the system 120 is high. In addition, the graphical representation 930 indicated by a minimum status index value close to zero may be a sign that is an intuitive reminder to the user that a fault may have occurred in a specific lower level system of the system 120 together with the above-described possibility.

As yet another example, graphical representation 1000 of FIG. 10 includes graphical representations 1010, 1020, and 1030. The graphic representation 1010 and the graphical representation 1020 respectively indicate a basic status index value and an operating status index value similar to each other, whereas the graphical representation 1030 indicates a significantly low minimum status index value. Thus, a user may predict that the system 120 is generally operating properly and a significant change in the operation should not occur, but a fault is highly likely to occur in a specific lower level system of the system 120.

FIG. 3 illustrates a user interface according to an embodiment.

A user interface 300 may be provided from the system monitoring apparatus 110 to the user device 160 according to a user input or a default setting. As shown in FIG. 3, the user interface 300 may include graphical representations 311, 321, 322, 323, 331, 332, 333, 341, 342, and 343 of index values calculated by the system monitoring apparatus 110 with respect to the highest level system of the above-described four hierarchies. The graphical representation 311 of the system status index of the highest level system of the hierarchy 1 may indicate a basic status index value, an operating status index value, and a minimum status index value of the highest level system in the same manner as in the graphical representation 200 of FIG. 2. Similarly, each of the graphical representations 321, 322, and 323 may indicate a corresponding one system status index among three hierarchy-2 systems, each of the graphical representations 331, 332, and 333 may indicate a corresponding one system status index among three hierarchy-3 systems, and each of the graphical representations 341, 342, and 343 may indicate a corresponding one system status index among three hierarchy 4-systems. Each of graphical representations 370, 380, and 390 may indicate a relationship between a system of a higher level hierarchy and sub-systems of the system. Meanwhile, as shown in FIG. 3, the identical value to the basic status index value in the graphical representations 341, 342, and 343 may be represented in a position where a minimum status index value appears in the other graphical representations 311, 321, 322, 323, 331, 332, and 333.

Hereinafter, implementation of the system monitoring apparatus 110 will be described in more detail. Referring again to FIG. 1, the system monitoring apparatus 110 may include a data collection unit 112, a calculation unit 114, a determination unit 116, and an interface unit 118. The respective components of the system monitoring apparatus 110 may be implemented by hardware such as, for example, a processor, a memory, a network interface, a display interface, an input/output interface, and the like of a computing device. The data collection unit 112, the calculation unit 114, and the determination unit 116 may be implemented in three separate processors, respectively. Alternatively, operations of the three units 112, 114, and 116 may be implemented in a single processor.

The data collection unit 112 may receive a data set including sensor values acquired by the target system 120 at a specific time point. When N sensor values are acquired, the corresponding data set may be represented as an N-dimensional data point X=(x₁, x₂, . . . , x_{N}). For convenience, this data set may be also referred to as a “data set X”.

In addition, the data collection unit 112 may collect, from the database 140, several data sets (each data set including N sensor values) which have been determined to represent a normal status or a faulty status of the system 120 after being acquired from the system 120. Each of these data sets may be represented as an N-dimensional data point Yᵢ=(yᵢ₁, yᵢ₂, . . . , y_{iN}). For convenience, each of these data sets may be referred to as a

The calculation unit 114 may calculate a data set (hereinafter, referred to as “data set Y”) most similar to the data set X among the data sets collected from the database 140. For this, the calculation unit 114 may calculate a degree of similarity between each of the data sets collected from the database 140 with the data set X. In one embodiment, the degree of similarity may indicate a distance between two data sets according to a predetermined distance metric. For example, the similarity may be given as a Euclidean distance. In this case, the similarity between the data set X and the data set Y may be represented as the following equation.

\sqrt{(x₁−y₁)²+(x₂−y₂)²+ . . . +(x_{N}−y_{N})²} [Equation 1]

In another embodiment, the degree of similarity may be related to a reciprocal of the distance between two data sets according to a predetermined distance metric.

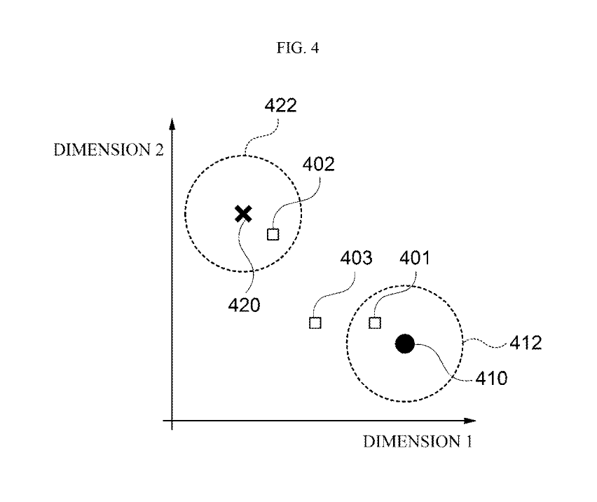

For a specific example, it is assumed that two data sets Yᵢ and Y₂ are collected from the database 140 and the two data sets are respectively represented as two 2-dimensional data points 410 and 420 of FIG. 4. When a 2-dimensional data point 401 represents the data set X, the data set Y₁ may be calculated as the data set Y more similar to the data set X representing the 2-dimensional data point 401. When a 2-dimensional data point 402 represents the data set X, the data set Y₂ may be calculated as the data set Y more similar to the data set X representing the 2-dimensional data point 402. As another example, when a 2-dimensional data point 403 represents the data set X, the data set Yᵢ may be calculated as the data set Y more similar to the data set X representing the 2-dimensional data point 403.

Furthermore, the calculation unit 114 may calculate an index associated with the status of the system 120 from the degree of similarity. In several embodiments, the calculation unit 114 may calculate a basic status index value from a distance r between the data set X and the data set Y.

When the data set Y is determined to represent the normal status of the system 120, the calculation unit 114 may calculate the basic status index value based on a decreasing function with respect to the distance r. For example, the basic status index value may be given as 1/(1+r). As another example, the basic status index value may be represented as the following equation.

$$\frac{1}{\frac{1 + r}{3 log ( 1 + \sqrt{{{Σ}_{d = 1}^{N} ( {max}_{d} - {min}_{d} )}^{2} )}}} \qquad [ Equation 2 ]$$

Here, when it is assumed that P data sets Y, are collected from the database 140, max_{d} is a maximum value among P elements y_{1d}, Y_{2d}, and y_{Pd}, and min_{d} is a minimum value among the P elements.

When the data set Y is determined to represent a faulty status of the system 120, the calculation unit 114 may calculate the basic status index value based on an increasing function with respect to the distance r. For example, the basic status index value may be given as 1-{1/(1+r)}. As another example, the basic status index value may be represented as the following Equation.

$$1 - \frac{1}{\frac{1 + r}{3 log ( 1 + \sqrt{{{Σ}_{d = 1}^{N} ( {max}_{d} - {min}_{d} )}^{2} )}}} \qquad [ Equation 3 ]$$

In this manner, the basic status index value may be calculated to be close to 1 when the data set X is closer to normal data, and calculated to be close to 0 when the data set X is closer to faulty data. Thus, when the data set Y has been already determined to be normal data, the basic status index value may suggest a high probability that the status of the system 120 may be good. In addition, when the data set Y has been already determined to be faulty data, the basic status index value may suggest a high probability that the status of the system 120 may be poor.

For a specific example, in FIG. 4, it is assumed that the data points 410 and 420 respectively represent normal data and faulty data. When the data point 401 or the data point 403 represents the data set X, the basic status index value of the system 120 may be calculated based on a decreasing function with respect to the distance r. On the contrary, when the data point 402 represents the data set X, the basic status index value of the system 120 may be calculated based on an increasing function with respect to the distance r.

According to several embodiments, the data set Y may be clustered data. In this manner, when the database 140 is constructed by utilizing a clustering method, whether the data set (for example, data set Y) stored in the database 140 is normal data or faulty data may be determined based on a ratio of the normal data to combined data and a preset threshold value. Furthermore, the calculated basic status index value may be adjusted in accordance with the above-described ratio. For example, when the ratio of the normal data to the combined data within the data set Y is 8:2 and a value calculated according to Equation 2 is 0.9, the basic status index value may be finally calculated as 0.9*0.8=0.72 (that is, 72%).

The determination unit 116 may determine whether the data set X indicates an abnormality sign status, a normal status, or a faulty status of the system 120 based on a threshold value associated with the data set Y and the degree of similarity.

For example, as described above, when the degree of similarity indicates the distance r between the data set X and the data set Y, the determination unit 116 may determine the status of the system 120 as follows:

When the distance r is smaller than a threshold value and the data set Y is determined to be normal data, the data set X is determined to represent the normal status of the system 120.

When the distance r is smaller than the threshold value and the data set Y is determined to be faulty data, the data set X is determined to represent the faulty status of the system 120.

When the distance r is larger than the threshold value, the data set X is determined to represent the abnormality sign status of the system 120.

According to an exemplary embodiment, it is assumed that a radius of a circle 412 of FIG. 4 is a threshold value R₁ associated with the data set Y₁ (normal data) represented by the data point 410 and a radius of a circle 422 of FIG. 4 is a threshold value R₂ associated with the data set Y₂ (faulty data) represented by the data point 420. For example, when the data point 401 represents the data set X, a distance between the data set X and the data set Yᵢ is smaller than R₁, and therefore the data set X may be determined to represent that the system 120 is normal. As another example, when the data point 402 represents the data set X, a distance between the data set X and the data set Y₂ is smaller than R₂, and therefore the data set X may be determined to represent that the system 120 is faulty. As still another example, when the data point 403 represents the data set X, and the distance between the data set X and the data set Y₁ is larger than R₁, the data set X is determined to represent that the system 120 shows an abnormality sign.

Although the status of the system 120 has been described as being determined based on a comparison between the distance from the data set X to the data set Y₁ and the threshold value R₁, embodiments are not limited thereto. The status of the system 120 may be determined based on a direct comparison between the degree of the similarity and a threshold value R₃ stored in the database 140. In this case, the determination unit 116 may determine the operation status of the system 120 as normal or faulty when the degree of the similarity is higher than the threshold value R₃. In addition, the determination unit may determine the operation status of the system 120 as abnormal when the degree of the similarity is lower than the threshold value R₃.

From the above, when the data set X is included within an effective range of the data set Y, the status represented by the data set X may correspond to the status represented by the data set Y. Otherwise, the status represented by the data set X may correspond to the abnormality sign status. Consequently, the threshold value associated with the data set Y may be referred to as an effective range of the data set Y. Such an effective range may be set using a variety of statistical methods (for example, by applying an n-fold cross validation method based on a history of the fault of the system 120). As the effective range is increased, the status of the system 120 is highly likely to be wrongly determined to be the faulty status or the normal status. On the other hand, as the effective range is reduced, the status of the system 120 may be more frequently determined to be the abnormality sign status. As an example, the appropriate effective range may be represented as the following equation.

$$2 log ( 1 + \frac{\sqrt{{{Σ}_{d = 1}^{N} ( {max}_{d} - {min}_{d} )}^{2} )}}{N} ) \qquad [ Equation 4 ]$$

In addition, when the data set X is determined to represent the faulty status or the abnormality sign status of the system 120, the calculation unit 114 may calculate a degree of contribution of each of the sensors within the system 120 with respect to the degree of similarity between the data set X and the data set Y. Next, the determination unit 116 may select at least one (for example, a sensor having the highest degree of contribution) among the sensors within the system 120 as a sensor to be inspected based on the calculated degree of contribution.

Meanwhile, as described above, the basic status index value may represent the status of the system 120 at the specific time point, but may not satisfactorily represent a gradual change of the status of the system 120. For example, it is difficult for a user to recognize a gradually accumulated change such as deterioration of devices within a building only using the basic status index value. Thus, the calculation unit 114 may additionally calculate the operating status index value as below.

The calculation unit 114 may acquire a plurality of time point-specific basic status indexes by repeatedly calculating the degree of similarity and the basic status index value for a plurality of time points within a specific monitoring time interval (for example, time interval having a length of u). Next, the calculation unit 114 may calculate the operating status index value from the acquired time point-specific basic status index values.

For example, the calculation unit 114 may calculate a weighted average of the plurality of time point-specific basic status index values as the operating status index value. Furthermore, the calculation unit 114 may give a specific weight to the above-described weighted average when at least two of the following conditions are satisfied.

It is assumed that P data sets Y, constructed in the database 140 exist within a predetermined range within N-dimensions. When the frequency of occurrence of an event in which the data set X is outside the range over time in the monitoring time interval exceeds a specific value (for example, a % of P), a change in the operation of the system 120 or deterioration thereof is highly likely to proceed rather than an occurrence of a temporary fault in the system 120. Here, a may be selected to minimize a residual sum of squares (RSS) using the n-fold cross validation method.

When the number of days when the frequency of occurrence of the event in which the data set X is outside the above-described range over time in the monitoring time interval (for example, u being 14 days) exceeds a specific value (for example, b % of P) is calculated and the calculated number of days is v (for example, 9 days) (smaller than u) or larger, the change in the operation of the system 120 or deterioration thereof is highly likely to proceed. Here, u, v, and b may be selected so as to minimize the RSS using the n-fold cross validation method.

When the number of days when an event of acquiring the data set X which is statistically very difficult to happen over time in the monitoring time interval (for example, u being 14 days) is generated at least once is calculated and the calculated number of days is w (smaller than u) or larger, the change in the operation of the system 120 or deterioration thereof is highly likely to proceed. Here, u and w may be selected so as to minimize the RSS using the n-fold cross validation method.

When at least two of the above-described conditions are satisfied, the operating status index value may be calculated as a value obtained by giving a weight p (where, 0<p<l) to a weighted average of the plurality of time point-specific basic status index values. Here, p may be selected so as to minimize the RSS using the n-fold cross validation method. For example, when the weighted average is 0.9, p is 0.5, and at least two among the above-described conditions are satisfied, the operating status index value may be finally calculated as 0.9*0.5=0.45 (that is, 45%).

Meanwhile, as described above, the operating environment 100 may include the plurality of target systems 120, and each of the systems 120 may be a lower level system included in a higher level system. In this case, the calculation unit 114 may acquire a plurality of lower level system-specific basic status index values by repeatedly calculating the degree of similarity and the basic status index value with respect to the plurality of lower level systems (that is, the plurality of the systems 120). In addition, the calculation unit 114 may calculate an index (hereinafter, referred to as a “higher level index”) associated with the status of the higher level system. For example, the calculation unit 114 may calculate, from the acquired lower level system-specific basic status index values, the basic status index value of the higher level system (for example, a typical average or weighted average of the lower level system-specific basic status index values).

Furthermore, the higher level index may further include at least one of the operating status index value of the higher level system and a lower level-status index value (for example, a minimum status index value) of the higher level system. For example, the calculation unit 114 may calculate the operating status index value of the higher level system in the similar manner to an operation of calculating the operating status index value of the system 120. In addition, the calculation unit 114 may calculate the lower level-status index value as a minimum value among the plurality of lower level system-specific basic status index values. Meanwhile, the determination unit 116 may select at least one lower level system to be inspected (for example, a lower level system having the lower level-status index value as the basic status index value).

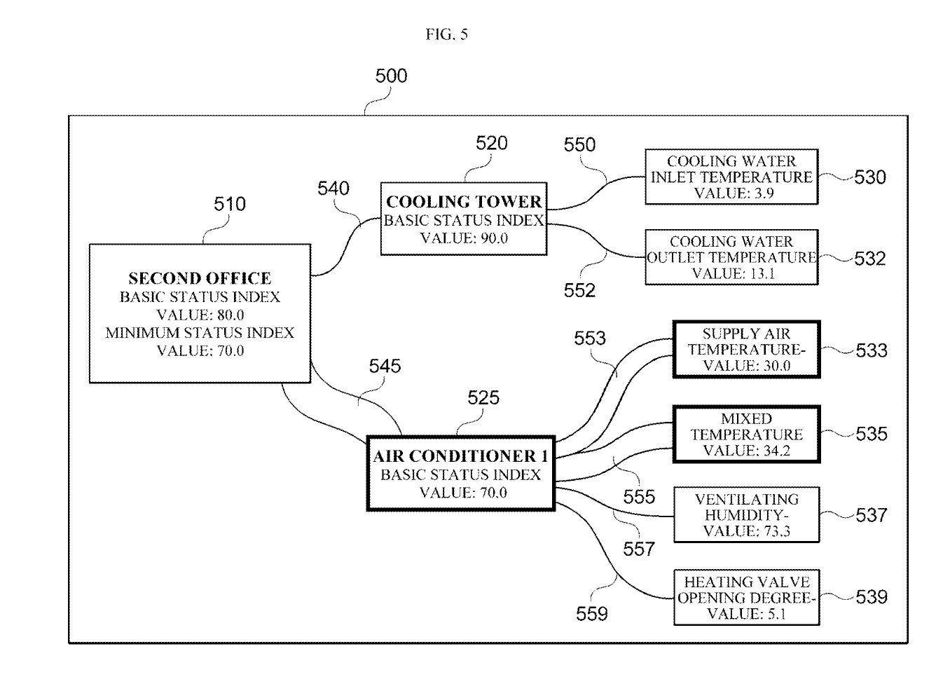

The interface unit 118 may provide a user interface to the user device 160. Hereinafter, with reference to FIG. 5, operations of the interface unit 118 will be described.

For example, the interface unit 118 may provide, to the user device 160 such as a display device) a graphical user interface 500 including a graphical representation 510 of an index associated with a status of a higher level system (for example, a building control system named “second office”).

In addition, the interface unit 118 may receive a user input such as mouse clicking. The interface unit 118 may receive a user input for detailed monitoring, and display an index associated with the status of the whole or each of the lower level systems on the user device 160 in response to the user input. For example, the user device 160 may display basic status index values associated with the status of an “air conditioner 1” device and a “cooling tower” device which are sub-systems of the above-described building control system. More specifically, when receiving a user input of selecting the graphical representation 510, the interface unit 118 may enable the user device 160 to visually indicate a graphical representation 520 and/or a graphical representation 525 through the graphical user interface 500. The graphical representation 520 and the graphical representation 525 may respectively indicate the basic status index value of the “air conditioner 1” device and the basic status index value of the “cooling tower” device. Furthermore, the interface unit 118 may enable the user device 160 to display at least one of the plurality of lower level systems in a highlighted format through the graphical user interface 500. For example, the user device 150 may display the “air conditioner 1” device, which has the minimum status index value as the basic status index value, in the highlighted format. As shown in FIG. 5, a connection line 545 of the graphical representation 510 and the graphical representation 525 may be thicker than a connection line 540 of the graphical representation 510 and the graphical representation 520, and a size of the graphical representation 525 and/or a thickness of the edge of the graphical representation 525 may be more noticeable than that of the graphical representation 520.

Similarly, the interface unit 118 may represent a sensor value of each of sensors included in the lower level system through the graphical user interface 500. For example, the interface unit 118 may represent the above-described sensor values while representing an index associated with the status of the lower level system through the graphical user interface 500 as shown by graphical representations 530, 532, 533, 535, 537, and 539. In addition, the interface unit 118 may enable the user device 160 to visually indicate the above-described sensor to be inspected (for example, “supply air sensor of the “air conditioner 1” device and a mixed temperature sensor) in a highlighted format through the user interface. For example, as shown in FIG. 5, connection lines 553 and 555 may be thicker than connection lines 550, 552, 557, and 559, and a thickness of the edge of each of the graphical representations 533 and 535 may be more noticeable than those of the graphical representations 530, 532, 537, and 539.

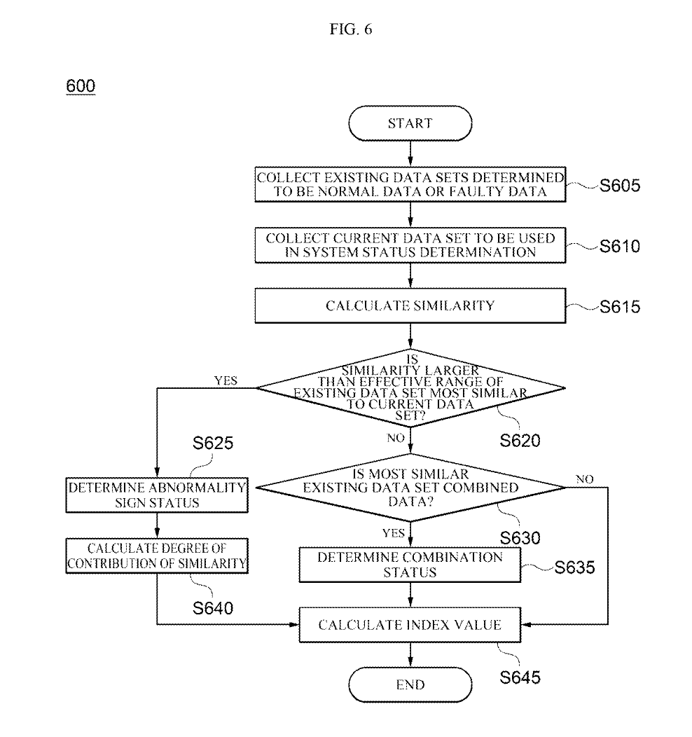

FIG. 6 illustrates a system monitoring process according to an embodiment. For example, a system monitoring process 600 may be performed by the system monitoring apparatus 110.

After a start operation, the system monitoring process 600 may proceed to operation S605. In operation S605, data which is determined to be normal data or faulty data is collected. For example, as shown in the following Table 1, whether data with respect to devices within a building is normal data or faulty data may be determined for each time interval. As indicated in Table 1, a variety of devices such as “air conditioner 1”, “air conditioner 6”, or “heat exchanger 1 for heating” may be included in the building.

TABLE 1

| Device within | | | Whether to |
|---|---|---|---|
| building | Start time point | End time point | be normal |
| Air conditioner 1 | 01-28-2013 | 02-28-2013 | normal |
| | 04:00:00. 000 | 15:30:00.000 | |
| Air conditioner 2 | 02-04-2013 | 03-04-2013 | Faulty |
| | 02:00:00.000 | 06:15:00. 000 | |
| . . . | . . . | . . . | |
| Air conditioner 6 | 02-17-2013 | 02-24-2013 | normal |
| | 05:00:00. 000 | 09:20:00.000 | |
| Air conditioner 6 | 03-01-2013 | 03-02-2013 | normal |
| | 02:00:00.000 | 13:55:00.000 | |
| Heat exchanger 1 | 01-28-2013 | 02-31-2013 | normal |
| for heating | 02:00:00.000 | 16:25:00.000 | |

In the building, the normal data or the faulty data may be stored in a database such as the database 140. For example, the database may maintain data sets (hereinafter, also referred to as “existing data set”) associated with the device which is referred to as “air conditioner 3”. For example, the existing data sets may include data sets shown in the following Table 2. As shown in Table 2, seven sensors are provided in the “air conditioner 3” device and each existing data set includes seven sensor values measured through the seven sensors at specific time points.

TABLE 2

| Device within | | Sensor |
|---|---|---|
| building | Sensor | value |
| Air conditioner 3 | Ambient temperature sensor | −1.94485 |
| Air conditioner 3 | Supply air temperature sensor | 21.0034 |
| Air conditioner 3 | Ventilation temperature sensor | 21.6901 |
| Air conditioner 3 | Mixed temperature sensor | 20.1794 |
| Air conditioner 3 | Cooling valve opening degree sensor | 0 |
| Air conditioner 3 | Heating valve opening degree sensor | 0 |
| Air conditioner 3 | Exhaust damper opening degree sensor | 0 |

The sensor values of the existing data sets may be normalized for each sensor. For example, when an average and a standard deviation of ambient temperature sensor values of the existing data sets are respectively s and t, the ambient temperature sensor value of the data set shown in Table 2 may be normalized to (−1.94485−s)/t. The normalized sensor value may be limited to a specific interval (for example, −1.0 to 1.0). In addition, the above-described interval may be divided into a plurality of sub-intervals, and a representative value (for example, a median value or an average value of sensor values within the sub-interval) may be assigned to each sub-interval.

In operation S610, a new data set (hereinafter, also referred to as “current data set”) to be used in determining a current status of the “air conditioner 3” device is collected from the “air conditioner 3” device. For example, the current data set may be given as data sets shown in the following Table 3.

TABLE 3

| Device within | | Sensor |
|---|---|---|
| building | Sensor | value |
| Air conditioner 3 | Ambient temperature sensor | −12.9672 |
| Air conditioner 3 | Supply air temperature sensor | 21.7777 |
| Air conditioner 3 | Ventilation temperature sensor | 20.7142 |
| Air conditioner 3 | Mixed temperature sensor | 20.9554 |
| Air conditioner 3 | Cooling valve opening degree sensor | 0 |
| Air conditioner 3 | Heating valve opening degree sensor | 5 |
| Air conditioner 3 | Exhaust damper opening degree sensor | 0 |

Sensor values of the current data set may be normalized for each sensor. For example, the ambient temperature sensor value of the data set presented in Table 3 may be normalized to (−12.9682−s)/t.

In operation S615, a degree of similarity between each of the existing data sets and the current data set is calculated. As described above, the degree of similarity may be a Euclidean distance between two data points. As another example, the degree of similarity may be a Manhattan distance between two data points. Through such calculation of the degree of similarity, the existing data set most similar to the current data set among the existing data sets may be determined. For convenience, it is assumed that the existing data set shown in Table 2 is most similar to the current data set shown in Table 3.

In operation S620, whether the degree of similarity between the existing data set and the current data set most similar to each other is larger than an effective range of the most similar existing data set is determined. When the degree of similarity is larger than or equal to the effective range, the current data set is determined to represent an abnormality sign status of the “air conditioner 3” device in operation S625. Furthermore, a history of such a determination may be recorded (for example, in the database), and a user may be notified of the abnormality sign status. When the degree of similarity is smaller than the effective range, whether the most similar existing data set is faulty data is determined in operation S630. When the most similar existing data set is determined to be faulty data, the current data set is determined to represent a faulty status of the “air conditioner 3” device in operation S635. A history of such a determination may be recorded (for example, in the database), and a user may be notified of the faulty status. Next, the process 600 proceeds to operation S645. In operation S630, when the most similar existing data set is determined to be normal data, the process 600 proceeds to operation S645.

Meanwhile, when the current data set is determined to represent the abnormality sign status of the “air conditioner 3” device, a sensor that most greatly affects such a determination may be identified. For this, in operation S640, a degree of contribution of each sensor with respect to the degree of similarity between the existing data set and the current data set most similar to each other may be calculated. A degree of contribution of a K-th sensor among N sensors may be represented as the following Equation 5.

$$\frac{{( {x}_{K} - {y}_{K} )}^{2}}{{( {x}_{1} - {y}_{1} )}^{2} + {( {x}_{2} - {y}_{2} )}^{2} + … + {( {x}_{N} - {y}_{N} )}^{2}} \qquad [ Equation 5 ]$$

Next, the process 600 proceeds to operation S645.

In operation S645, an index associated with the status of the “air conditioner 3” device is calculated. Such an index may include the basic status index value calculated as described above, and additionally include the operating status index value. Meanwhile, operations S610 to S645 may be repeatedly performed with respect to each of the devices within the building, and therefore an index associated with the status of the building that is the higher level system may be calculated. Such an index may include the basic status index value calculated as described above, and additionally include the operating status index value and/or the minimum status index value.

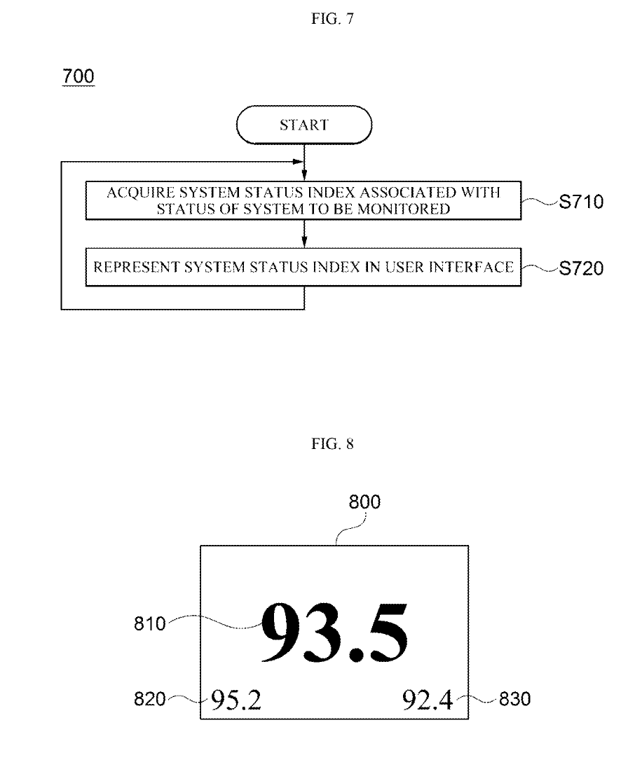

FIG. 7 illustrates a system monitoring process according to an embodiment. For example, a system monitoring process 700 may be performed by the system monitoring apparatus 110.

After a start operation, the process 700 proceeds to operation S710. In operation S710, a system status index (for example, the target system 120 and/or each lower level system of the target system 120) associated with the status of the target system is acquired. Such a system status index includes a basic status index value associated with a time point-specific status of the system. In addition, the system status index may further include an operating status index value associated with a time interval-specific status of the system, a lower level-status index value associated with a time point-specific status of a specific lower level system, if any, of the system, or both.

According to several embodiments, the system monitoring apparatus 110 (the calculation unit 114 thereof) may acquire such a system status index through operations which are the same as or similar to the above-described operations. For example, the system includes a plurality of lower level systems, a higher level index (that is, system status index of the system 120) may be acquired together with a plurality of lower level system-specific system status index (each of which is associated with the status of a corresponding lower level system among the lower level systems of the system 120).

Specifically, the basic status index value may represent the status of the system at a specific time point. For example, the calculation unit 114 may acquire the basic status index value for each time point. In addition, the operating status index value may represent the status of the system over a time interval from a time point prior to the specific time point up to the specific time point. For example, the calculation unit 114 may acquire the operating status index value using a plurality of time point-specific basic status index values, and each of the time point-specific basic status index values may be associated with the status of the system at one time point within the time interval. Furthermore, the lower level-status index value may represent the status of a specific lower level system at the specific time point. For example, when the system includes a plurality of lower level systems (including the above-described specific lower level system), the calculation unit 114 may acquire the lower level-status index value using a plurality of lower level system-specific basic status index values, and each of the lower level system-specific basic status index values may represent the status of a corresponding lower level system among the plurality of lower level systems at the above-described specific time point. Such a lower level-status index value may be a minimum status index value that is a minimum value among the plurality of lower level system-specific basic status index values.

In operation S720, the acquired system status index is represented in the user interface. According to several embodiments, the interface unit 118 of the system monitoring apparatus 110 may visually indicate the system status index through the user interface as shown by graphical representations 200, 800, 900, and 1000 of FIG. 2 and FIGS. 8 to 10. In addition, when the system includes a plurality of lower level systems, the interface unit 118 may represent the system and at least a partial index among the lower level systems on the user interface in a tree structure in a similar manner to the user interfaces 300 and 500 shown in FIGS. 3 and 5. In particular, as shown in FIG. 5, the interface unit 118 may represent at least one (for example, a specific lower level system from which the minimum status index value of the system has originated) among the lower level systems of the system, on the user interface in a highlighted format. For example, in FIG. 5, the size of each of the graphical representations 525, 533, and 535 and the thickness of the edge thereof may be noticeably shown, and the thickness and/or shape of each of the connection lines 545, 553, and 555 may be noticeably shown. Such a user interface may enable a user to easily recognize the status of the system to be monitored, and to efficiently discern a lower level system in which a fault may occur.

Next, when a new system status index is acquired, the process 700 repeatedly performs the above-described operations S710 and S720 with respect to the new system status index.

As described above, according to the embodiments, it may be determined that the system to be monitored is normal or faulty, and determined that a potential fault or an abnormality sign occurs in the system to be monitored.

According to the embodiments, even though data representing a faulty status of the system or a fault occurrence situation associated with the data is not defined (for example, by specialists with detailed knowledge of the system), the status of the system may be determined to be an abnormality sign status only using data representing that the status of the system is normal, and therefore the system may be economically and conveniently operated.

According to the embodiments, the status of the system to be monitored may be efficiently presented, and an element that is a cause of the abnormality sign or fault of the system to be monitored may be easily recognized.

Meanwhile, an exemplary embodiment can include a computer-readable storage medium including a program for performing the methods described herein on a computer. The computer-readable storage medium may separately include program commands, local data files, local data structures, etc. or include a combination of them. The computer-readable storage medium may be specially designed and configured for the embodiments described above, or known and available to those of ordinary skill in the field of computer software. Examples of the computer-readable storage medium include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and execute program commands. Examples of the program commands may include high-level language codes executable by a computer using an interpreter, etc., as well as machine language codes made by compilers.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. An apparatus for monitoring a target system comprising:
a data collection unit configured to collect a first data set acquired from the target system at a first time point and determined to represent a status of the target system and a second data set acquired from the target system at a second time point subsequent to the first time point; and
a calculation unit configured to calculate at least one index associated with the status of the system based on the first data set and the second data set,
wherein at least one of the data collection unit and the calculation unit are implemented via at least one central processing unit or at least one hardware processor.

2. The apparatus of claim 1, wherein the first data set indicates whether the status of the target system at the first time point is a normal status or a faulty status.

3. The apparatus of claim 1, wherein the at least one index comprises a basic status index value associated with the status of the target system at the second time point.

4. The apparatus of claim 3, wherein the at least one index further comprises an operating status index value associated with the status of the target system over a time interval from the first time point to the second time point.

5. The apparatus of claim 4, wherein the calculation unit is further configured to calculate the operating status index value from a plurality of time point-specific basic status index values, and each of the plurality of time point-specific basic status index values is associated with the status of the target system at one time point within the time interval.

6. The apparatus of claim 3, wherein the target system comprises a plurality of lower level systems, and the at least one index further comprises a lower level-status index value associated with a status of one lower level system among the plurality of lower level systems at the second time point.

7. The apparatus of claim 6, wherein the calculation unit is further configured to calculate the lower level-status index value from a plurality of lower level system-specific basic status index values, and each of the plurality of lower level system-specific basic status index values is associated with the status of one lower level system among the plurality of lower level systems at the second time point.

8. The apparatus of claim 6, wherein the lower level-status index value is a minimum value among the plurality of lower level system-specific basic status index values.

9. The apparatus of claim 1, further comprising:
an interface unit configured to indicate the at least one index through a user interface.

10. The apparatus of claim 9, wherein the system comprises a plurality of lower level systems, the calculation unit is further configured to calculate a plurality of lower level system-specific indexes, the interface unit is further configured to indicate at least a part of the plurality of lower level system-specific indexes through the user interface in response to reception of a user input, and each of the plurality of lower level system-specific indexes is associated with a status of a corresponding lower level system among the plurality of lower level systems.

11. The apparatus of claim 10, wherein the interface unit is further configured to visually indicate at least one of the plurality of lower level systems in a highlighted format.

12. The apparatus of claim 2, wherein the calculation unit is further configured to calculate a degree of similarity between the first data set and the second data set, the apparatus further comprising:
a determination unit configured to determine, based on a threshold value associated with the first data set and the degree of similarity, whether the second data set represents an abnormality sign status, the normal status, or the faulty status of the target system.

13. The apparatus of claim 12, wherein the calculation unit further calculates the at least one index from the degree of similarity.

14. The apparatus of claim 12, wherein the first data set comprises a plurality of first sensor values measured through a plurality of sensors installed in association with the system, and the second data set comprises a plurality of second sensor values measured through the plurality of sensors.

15. The apparatus of claim 14, wherein the calculation unit is further configured to calculate a degree of contribution of each of the plurality of sensors with respect to the degree of similarity when the second data set is determined to represent the faulty status or the abnormality sign status.

16. The apparatus of claim 15, wherein the determination unit is further configured to select, based on the calculated degree of contribution, one of the plurality of sensors as a sensor to be inspected.

17. The apparatus of claim 12, wherein the degree of similarity represents a distance between the first data set and the second data set in accordance with a preset distance metric.

18. The apparatus of claim 17, wherein the second data set is determined to represent the normal status when the distance is smaller than the threshold value and the first data set is determined to represent the normal status, the second data set is determined to represent the faulty status when the distance is smaller than the threshold value and the first data set is determined to represent the faulty status, and the second data set is determined to represent the abnormality sign status when the distance is larger than the threshold value.

19. The apparatus of claim 17, wherein the calculation unit is further configured to calculate, from the distance, a basic status index value associated with the status of the target system at the second time point, the basic status index value is calculated based on a decreasing function with respect to the distance when the first data set is determined to represent the normal status, and the basic status index value is calculated based on an increasing function with respect to the distance when the first data set is determined to represent the faulty status.

20. A system monitoring method which is implemented by a computing device, comprising:
collecting a first data set acquired from a target system at a first time point and determined to represent a status of the target system and a second data set acquired from the system at a second time point subsequent to the first time point; and
calculating at least one index associated with the status of the target system based on the first data set and the second data set.

21. The system monitoring method of claim 20, wherein the first data set is determined to represent the status of the target system at the first time point as a normal status or a faulty status.

22. The system monitoring method of claim 20, wherein the at least one index comprises a basic status index value associated with the status of the target system at the second time point.

23. The system monitoring method of claim 22, wherein the at least one index further comprises an operating status index value associated with the status of the target system over a time interval from the first time point to the second time point.

24. The system monitoring method of claim 23, wherein the calculating comprises calculating the operating status index value from a plurality of time point-specific basic status index values, and each of the plurality of time point-specific basic status index values is associated with the status of the target system at one time point within the time interval.

25. The system monitoring method of claim 22, wherein the target system comprises a plurality of lower level systems, and the at least one index further comprises a lower level-status index value associated with a status of one lower level system among the plurality of lower level systems at the second time point.

26. The system monitoring method of claim 25, wherein the calculating comprises calculating the lower level-status index value from a plurality of lower level system-specific basic status index values, and each of the plurality of lower level system-specific basic status index values is associated with the status of one lower level system among the plurality of lower level systems at the second time point.

27. The system monitoring method of claim 25, wherein the lower level-status index value is a minimum value among the plurality of lower level system-specific basic status index values.

28. The system monitoring method of claim 20, further comprising:
representing the at least one index through a user interface.

29. The system monitoring method of claim 28, further comprising:
calculating a plurality of lower level system-specific indexes corresponding to a plurality of lower level systems of the target system; and
indicating at least a part of the plurality of lower level system-specific indexes through the user interface in response to reception of a user input,
wherein each of the plurality of lower level system-specific indexes is associated with a status of a corresponding lower level system among the plurality of lower level systems.

30. The system monitoring method of claim 29, further comprising:
representing at least one of the plurality of lower level systems in a highlighted format.

31. The system monitoring method of claim 21, further comprising:
calculating a degree of similarity between the first data set and the second data set; and
determining, based on a threshold value associated with the first data set and the degree of similarity, whether the second data set represents an abnormality sign status, the normal status, or the faulty status of the target system.

32. The system monitoring method of claim 31, further comprising:
calculating the index from the degree of similarity.

33. The system monitoring method of claim 31, wherein the first data set comprises a plurality of first sensor values measured through a plurality of sensors installed in association with the target system, and the second data set includes a plurality of second sensor values measured through the plurality of sensors.

34. The system monitoring method of claim 33, further comprising:
calculating a degree of contribution of each of the plurality of sensors with respect to the degree of similarity when the second data set is determined to represent the faulty status or the abnormality sign status.

35. The system monitoring method of claim 34, further comprising:
selecting, based on the calculated degree of contribution, one of the plurality of sensors as a sensor to be inspected.

36. The system monitoring method of claim 31, wherein the degree of similarity represents a distance between the first data set and the second data set in accordance with a preset distance metric.

37. The system monitoring method of claim 36, wherein the second data set is determined to represent the normal status when the distance is smaller than the threshold value and the first data set is determined to represent the normal status, the second data set is determined to represent the faulty status when the distance is smaller than the threshold value and the first data set is determined to represent the faulty status, and the second data set is determined to represent the abnormality sign status when the distance is larger than the threshold value.

38. The system monitoring method of claim 36, further comprising:
calculating, from the distance, a basic status index value associated with the status of the target system at the second time point,
wherein the basic status index value is calculated based on a decreasing function with respect to the distance when the first data set is determined to represent the normal status, and the basic status index value is calculated based on an increasing function with respect to the distance when the first data set is determined to represent the faulty status.

39. A system monitoring apparatus comprising:
a calculation unit configured to acquire a system status index comprising a basic status index value associated with a time point-specific status of a target system, at least one of an operating status index value associated with a time interval-specific status of the target system, and a lower level-status index value associated with a time point-specific status of a specific lower level system of the target system; and
an interface unit configured to indicate the system status index through a user interface
wherein at least one of the calculation unit and the interface unit are implemented via at least one central processing unit or at least one hardware processor.

40. The system monitoring apparatus of claim 39, wherein the basic status index value represents the status of the target system at a second time point, the operating status index value represents the status of the target system over a time interval from a first time point preceding the second time point to the second time point, and the lower level-status index value represents the status of the specific lower level system at the second time point.

41. The system monitoring apparatus of claim 39, wherein the calculation unit is configured to acquire the operating status index value using a plurality of time point-specific basic status index values, and each of the plurality of time point-specific basic status index values is associated with the status of the target system at one time point within the time interval.

42. The system monitoring apparatus of claim 39, wherein the calculation unit is configured to acquire the lower level-status index value using a plurality of lower level system-specific basic status index values, the system comprises a plurality of lower level systems, the plurality of lower level systems comprises the specific lower level system, and each of the plurality of lower level system-specific basic status index values is associated with a status of one lower level system among the plurality of lower level systems at the second time point.

43. The system monitoring apparatus of claim 42, wherein the lower level-status index value is a minimum value among the plurality of lower level system-specific basic status index values.

44. The system monitoring apparatus of claim 39, wherein the system comprises a plurality of lower level systems, the plurality of lower level systems comprises the specific lower level system, the calculation unit is further configured to acquire a plurality of lower level system-specific system status indexes, each of the plurality of lower level system-specific system status indexes is associated with a status of a corresponding lower level system among the plurality of lower level systems, and the interface unit is further configured to represent at least a part of the plurality of lower level system-specific system status indexes through the user interface.

45. The system monitoring apparatus of claim 44, wherein the interface unit is further configured to represent at least one of the plurality of lower level systems in a highlighted format through the user interface.

46. A system monitoring method comprising:
acquiring a system status index comprising a basic status index value associated with a time point-specific status of a target system, at least one of an operating status index value associated with a time interval-specific status of the target system, and a lower level-status index value associated with a time point-specific status of a specific lower level system of the target system; and
representing the system status index through a user interface.

47. The system monitoring method of claim 46, wherein the basic status index value represents the status of the target system at a second time point, the operating status index value represents the status of the target system over a time interval from a first time point preceding the second time point to the second time point, and the lower level-status index value represents the status of the specific lower level system at the second time point.

48. The system monitoring method of claim 46, wherein the acquiring comprises acquiring the operating status index value using a plurality of time point-specific basic status index values, and each of the plurality of time point-specific basic status index values is associated with the status of the system at one time point within the time interval.

49. The system monitoring method of claim 46, wherein the acquiring comprises acquiring the lower level-status index value using a plurality of lower level system-specific basic status index values, the system comprises a plurality of lower level systems, the plurality of lower level systems comprises the specific lower level system, and each of the plurality of lower level system-specific basic status index values is associated with a status of one lower level system among the plurality of lower level systems at the second time point.

50. The system monitoring method of claim 49, wherein the lower level-status index value is a minimum value among the plurality of lower level system-specific basic status index values.

51. The system monitoring method of claim 46, further comprising:
acquiring a plurality of lower level system-specific system status indexes corresponding to a plurality of lower level systems of the target system, wherein each of the plurality of lower level system-specific system status indexes is associated with a status of a corresponding lower level system among the plurality of lower level systems, and
representing at least a part of the plurality of lower level system-specific system status indexes through the user interface.

52. The system monitoring method of claim 51, further comprising: representing at least one of the plurality of lower level systems in a highlighted format through the user interface.

53. A non-transitory computer-readable storage medium storing a program that is executable by a processor to perform a method comprising:
collecting a first data set acquired from a target system at a first time point and determined to represent a status of the system and a second data set acquired from the system at a second time point subsequent to the first time point; and
calculating at least one index associated with the status of the target system based on the first data set and the second data set.

54. A non-transitory computer-readable storage medium storing a program that is executable by a processor to perform a method comprising:
acquiring a system status index comprising a basic status index value associated with a time point-specific status of a target system, at least one of an operating status index value associated with a time interval-specific status of the target system, and a lower level-status index value associated with a time point-specific status of a specific lower level system of the target system; and
representing the system status index through a user interface.

55. An apparatus for monitoring a target system comprising:
a database configured to store a first data set corresponding to a first sensing value acquired from the target system at a first time point and indicating an operation status of the target system at the first time point;
a data collection unit configured to collect a second data set corresponding to a second sensing value acquired from the target system at a second time point subsequent to the first time point; and
a determination unit configured to determine an operation status of the target system at the second time point based on a degree of similarity between the first data set and the second data set
wherein at least one of the data collection unit and the determination unit are implemented via at least one central processing unit or at least one hardware processor.

56. The apparatus of claim 55, wherein the determination unit is further configured to determine the operation status at the second time point as normal or faulty based on the degree of similarity and the operation status at the first time point in response to the degree of the similarity being higher than a threshold value.

57. The apparatus of claim 56, wherein the determination unit is further configured to determine the operation status at the second time point as abnormal in response to the degree of similarity being lower than the threshold value.
